(19) United States
(12) Patent Application Publication
(10) Pub. No.: US 2004/0260617 A1
(43) Pub. Date: Dec. 23, 2004

(54) Flavor ordering system

(76) Inventors: Richard H. Davidson, Pattenburg, NJ (US); Craig D. Hagelin, Morristown, NJ (US); Joseph F. Watkins JR., Chester, NJ (US)

Correspondence Address: Arnold D. Litt, Herten Burstein Sheridan Cevasco Bottinelli & Litt, Court Plaza North, 25 Main Street, Hackensack, NJ, 07601, US

(21) Appl. No.: 10/600,359

(22) Filed: Jun. 23, 2003

(51) Int. Cl. G06F 17/60

(52) U.S. Cl. 705/26

(57) ABSTRACT

A system for the distribution of flavors is disclosed. The system includes a plurality of consumer workstations linked to a central processing hub. The central processing hub includes means for providing consumers with information regarding flavors. The means for providing includes a flavor search system through which a consumer may identify desired flavor based upon a series of input criteria.

### BACKGROUND OF THE INVENTION

1. Field of the Invention

The invention relates to a flavor ordering system. More particularly, the invention relates to a computer system utilized in the automated configuration and ordering of flavors to be used in bakery, dairy, beverage, confection and/or oral care products.

2. Background of the Invention

In the manufacture of food and other edible products, the flavor of the product is often highly associated with the success or failure of the product itself. Manufacturers take great care in choosing appropriate flavors for incorporation in their products. The selection process used in determining an appropriate flavor for an edible product can be time consuming and highly involved.

As such, it is important for consumers that an efficient system is provided whereby consumers may readily select and analyze potential flavors for utilization in their products. To date, systems fully providing for consumers needs are not available. With this in mind, a system is needed which provides consumers with a convenient, efficient and readily accessible manner in which to study, evaluate and order flavors for their products. The present invention provides such a system.

### SUMMARY OF THE INVENTION

It is, therefore, an object of the present invention to provide a system for the distribution of flavors. The system includes a plurality of consumer workstations linked to a central processing hub. The central processing hub includes means for providing consumers with information regarding flavors. The means for providing includes a flavor search system through which a consumer may identify desired flavor based upon a series of input criteria.

It is also an object of the present invention to provide a system wherein the criteria include general flavor type.

It is another object of the present invention to provide a system wherein the criteria further includes flavor descriptors.

It is a further object of the present invention to provide a system wherein the criteria further includes flavor legal status.

It is also an object of the present invention to provide a system wherein the flavor legal status is chosen from the group consisting of artificial, natural and artificial natural flavor, natural type and natural WONF.

It is also another object of the present invention to provide a system wherein the criteria further includes solubility of the flavor.

It is also a further object of the present invention to provide a system wherein means for providing further prompts the user to identify the usage category for the chosen flavor.

It is yet another object of the present invention to provide a system wherein the usage categories are selected from the group consisting of bakery, dairy, beverage, confections and oral care.

It is also an object of the present invention to provide a system wherein the means for providing also including means for permitting a user to select the preparation of a custom flavor.

It is a further object of the present invention to provide a system wherein the consumer workstations and the central processing hub are connected via the Internet.

It is another object of the present invention to provide a system further including means for providing general information regarding flavors.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a schematic of the present system.

FIG. 2 is an exemplary web page representing the home page in accordance with the present invention.

FIG. 3 is a web page providing information regarding “Flavors” in accordance with the present invention.

FIG. 4 is a web page in accordance with the present invention providing information regarding “Fragrances”.

FIG. 5 is the introductory page for the search system in accordance with the present invention.

FIG. 6 is a web page for requesting a consumer product flavor.

FIG. 7 is a web page requesting end usage parameters.

FIG. 8 is a web page showing a customer order.

FIG. 9 is a web page prompting a user to select a flavor type and associated parameters.

FIG. 10 is a web page requesting the user to select various descriptors regarding a selective flavor.

FIG. 11 is a search results page.

FIG. 12 provides flavor details.

FIG. 13 is a web page prompting a user to select end usage parameters.

FIG. 14 is a web page showing an exemplary consumer order.

FIG. 15 is a web page transmitted when no flavors match selected descriptors.

FIG. 16 prompts users to select end usage parameters in conjunction with a custom flavor inquiry.

FIG. 17 is a web page providing help information.

### DESCRIPTION OF THE PREFERRED EMBODIMENT

The detailed embodiment of the present invention is disclosed herein. It should be understood, however, that the disclosed embodiment is merely exemplary of the invention, which may be embodied in various forms. Therefore, the details disclosed herein are not to be interpreted as limiting, but merely as the basis for the claims and as a basis for teaching one skilled in the art how to make and/or use the invention.

With reference to the attached drawings, a system is disclosed for the review, configuration and ordering of flavors for use in the manufacture of various products. The present system facilitates the ready distribution of flavors to consumers who require various flavors in the manufacture of their products.

In accordance with a preferred embodiment of the present invention, “flavor(s)” as used throughout the present specification is meant to refer to an ingredient added to various products particularly, food and other edible products) for the purpose of imparting a desired taste to the resulting product. The flavors distributed in accordance with the present invention, may be Artificial, BATF Natural, Natural & Artificial, Natural Flavor, Natural Type (that is, flavors whose components are natural, but the named flavor does not exist in nature), Natural WONF (“With Other Natural Flavors”, for example, one might make cherry flavor that has natural components from plum

While flavors are distributed in accordance with a preferred embodiment as described herein, it is contemplated the teachings of the present invention may be readily applied in the distribution of fragrances used in the manufacture of various products without departing from the spirit of the present invention.

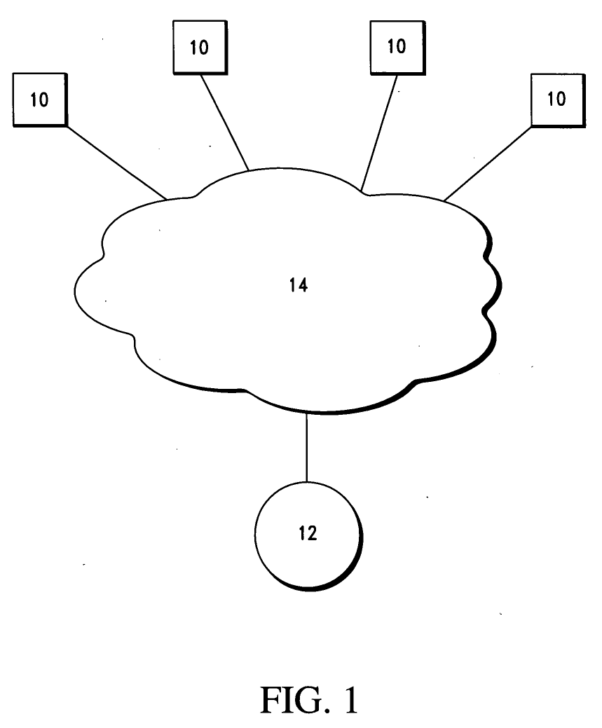

The present system operates over a global communication network with a plurality of consumer workstations 10 connected to a central processing hub 12 (see FIG. 1). All information retrieved by the consumers is stored and transmitted by the central processing hub 12. In accordance with a preferred embodiment of the present invention, consumers link to the central processing hub 12 via the Internet 14 using standard communication techniques.

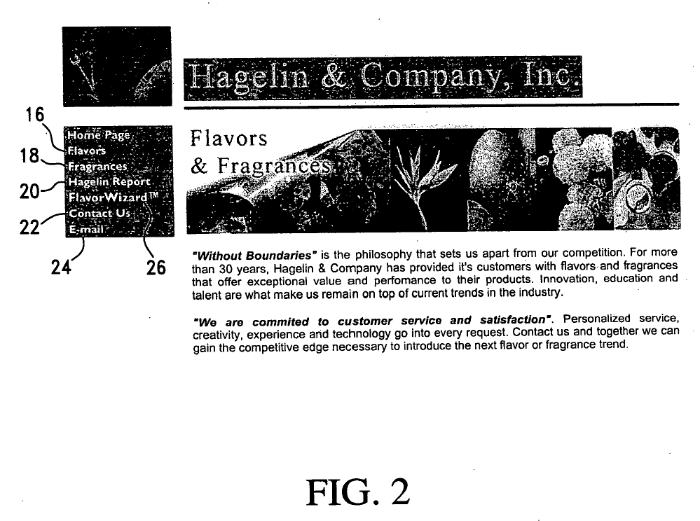

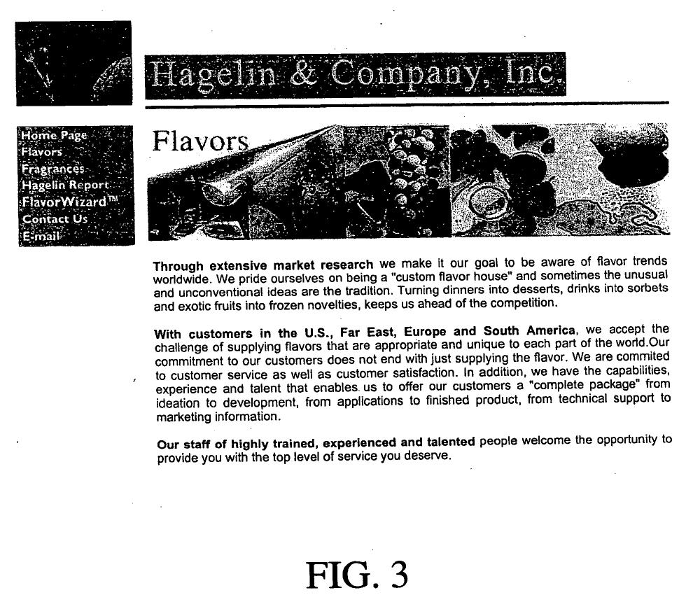

Upon accessing the central processing hub 12, and with reference to FIG. 2, a consumer is greeted with a home page describing the company operating the present system and providing the consumer with a variety of options for proceeding. For example, the home page provides the consumer with the opportunity to obtain information regarding the company's flavors and fragrances by clicking upon the “Fragrances” or “Flavors” links 16, 18. If a consumer selects to obtain information generally regarding the flavors offered by the company, he or she may click upon the “Flavors” link 16 and the page shown at FIG. 3 is transmitted to the consumer. This page provides information regarding the manufacture and research relating to flavors developed, manufactured and sold by the company.

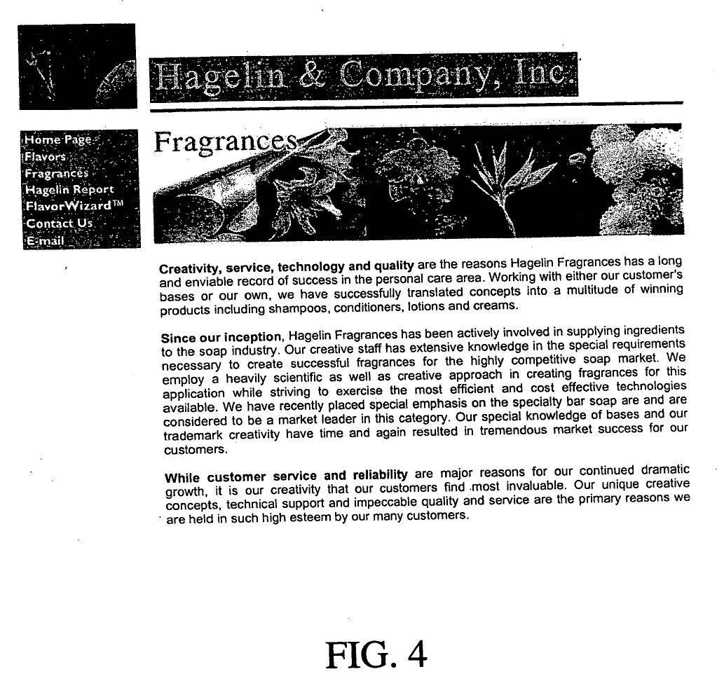

Similarly, if a consumer wishes to obtain information regarding fragrances offered by the company, he or she may simply click upon the “Fragrances” link 18 and a web page containing information relating to fragrances is transmitted to the consumer for his or her review (see FIG. 4). Further, web pages relating to the company itself 20, contact information 22 and email information 24 may also be provided by simply clicking upon the associated links.

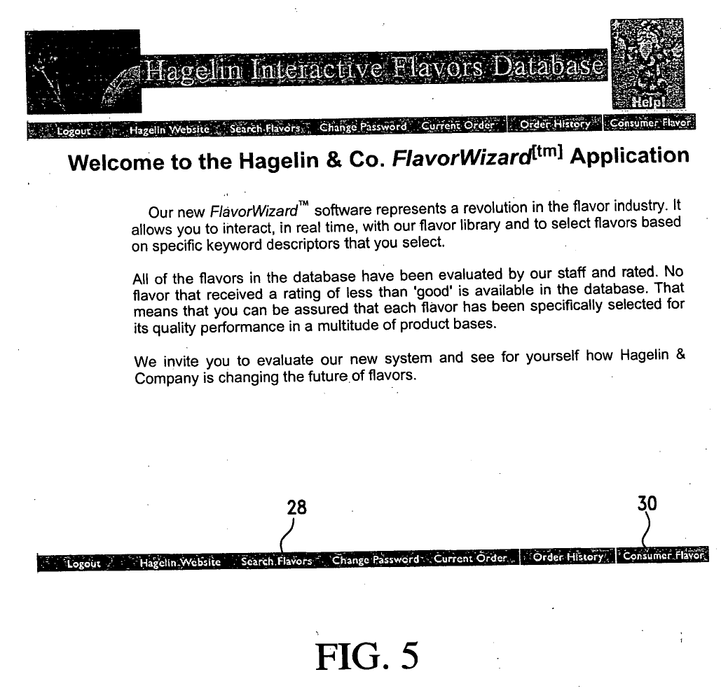

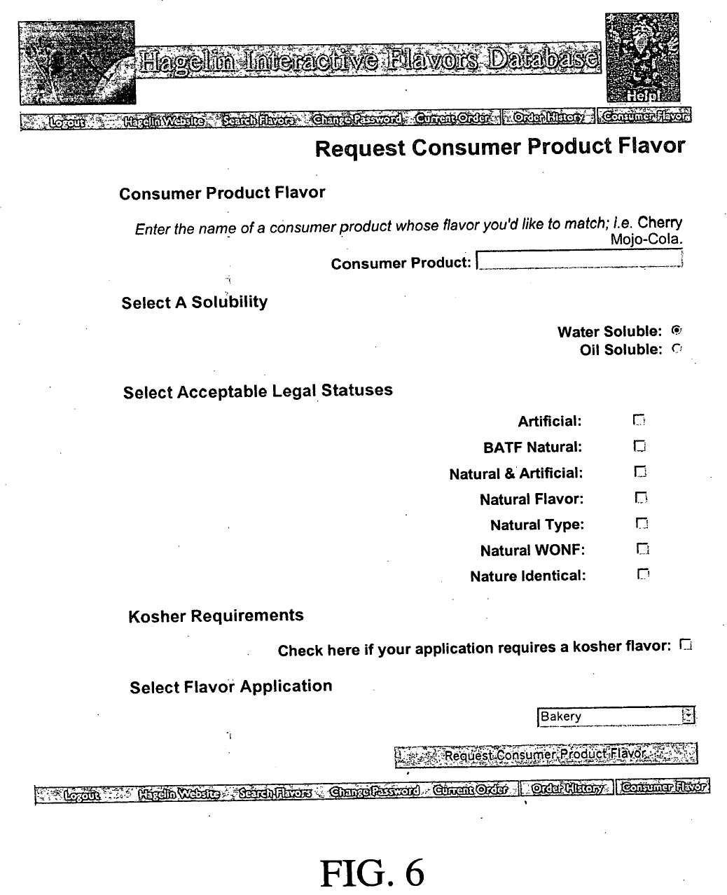

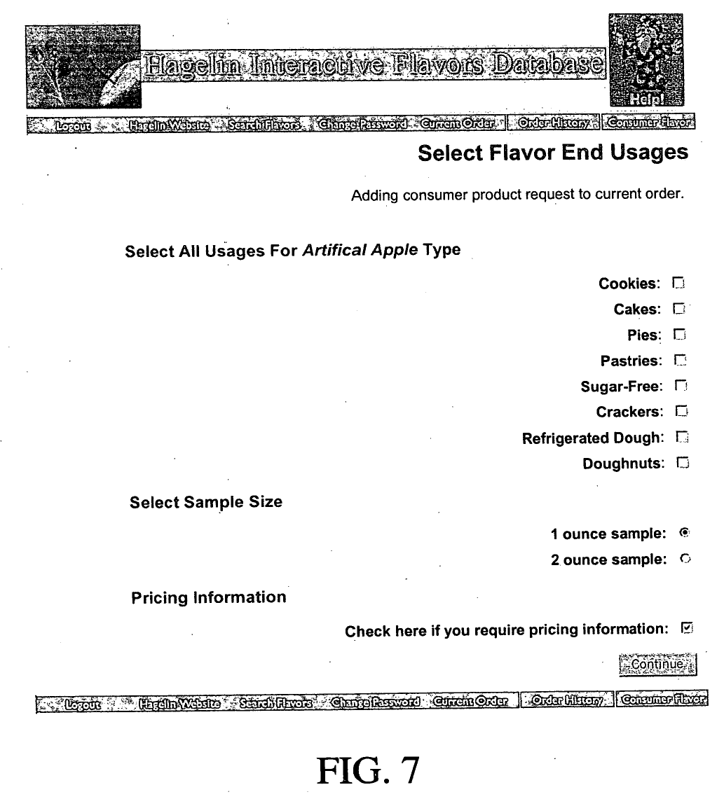

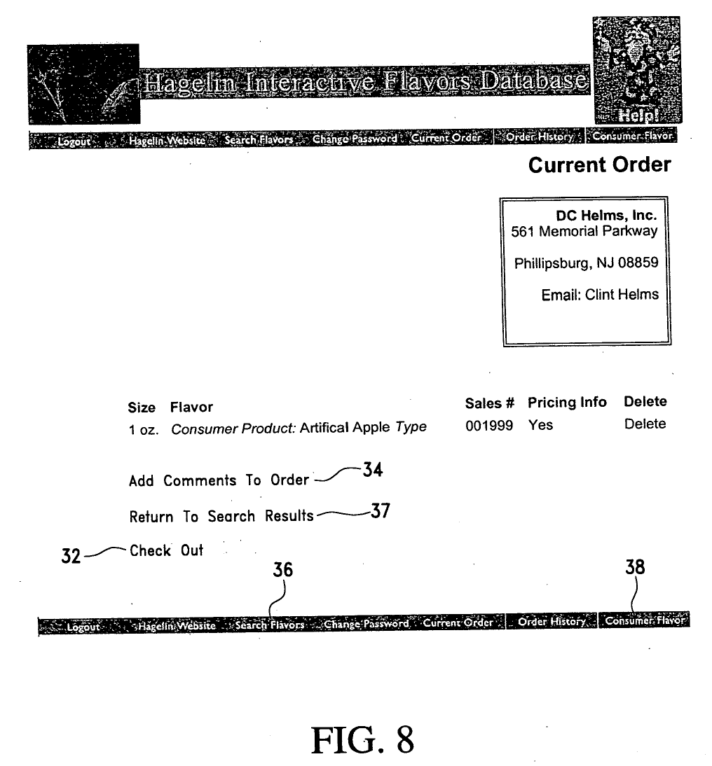

Further to the links discussed above, a user wishing to order or explore various flavors may enter the flavor searching system, or FLAVORWIZARD as it is called in accordance with a preferred embodiment of the present invention, by clicking upon the “FLAVOR WIZARD” link 26. Upon actuation of the flavor searching system, the user is provided with an interface as shown in FIG. 5. The initial page for the flavor searching system asks the consumer whether he or she wishes to search flavors 28 or request consumer product flavors 30. If the user chooses to request a consumer product flavor, the user is transmitted to a web page as shown in FIG. 6 and asked to list the consumer product flavor, select acceptable legal statuses for the flavor, select the solubility and select amongst a variety of flavor applications (or usages) (for example, bakery dairy, beverage, confection or oral care). The user is also prompted to indicate whether Kosher flavors are required. Thereafter, a subsequent web page is transmitted and the user is prompted to select the usage parameters as shown in FIG. 7. The user is also asked for the required ample size and whether pricing information is required. The item is then added to the consumer's order sheet (see FIG. 8). Thereafter, the consumer may check out 32, add order comments 34, perform a new flavor search 36, return to a prior search result 37 or request another product flavor 38.

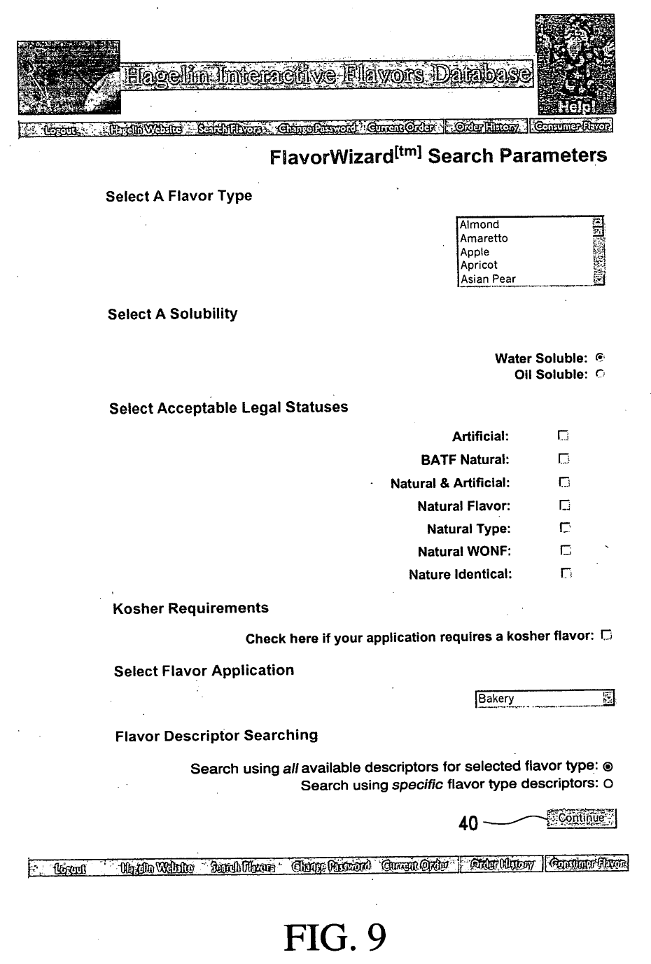

As mentioned above, in addition to allowing the consumer to request consumer product flavors, the present system allows the user to search amongst a plurality of available flavors and select desired flavors for ordering. The search system is entered by clicking upon the “Search Flavors” link 28 on the page shown in FIG. 4 or by clicking upon the “Search Flavors” link 36 found at the bottom of most web pages provided in accordance with the present system When this button is clicked, a web page as shown in FIG. 9 is provided for the consumer. The web page lists a wide variety of flavors, including, but not limited to, almond, amaretto, apple, apricot, etc. The total list of the flavors available is provided in the attached Appendix A

In addition to selecting the desired flavor, for example, blueberry, the consumer is also prompted to select the acceptable legal status for the application to which the flavor is going to be used. For example, the consumer must select between Artificial BATF Natural, Natural & Artificial, Natural Flavor, Natural Type, Natural WONF.

The user is also prompted to select the flavor application, which is chosen from bakery, beverage, confections, dairy and oral care. While a specific list of applications are presented herein, other applications maybe employed without departing from the spirit of the present invention.

The user is further requested to select the solubility of the flavor and may select either water soluble flavors or oil soluble flavors. The user may also select whether kosher flavoring is required in accordance with the desired application. The user is also prompted as to whether all flavor descriptions should be used when searching or whether specific flavor type descriptions should be used.

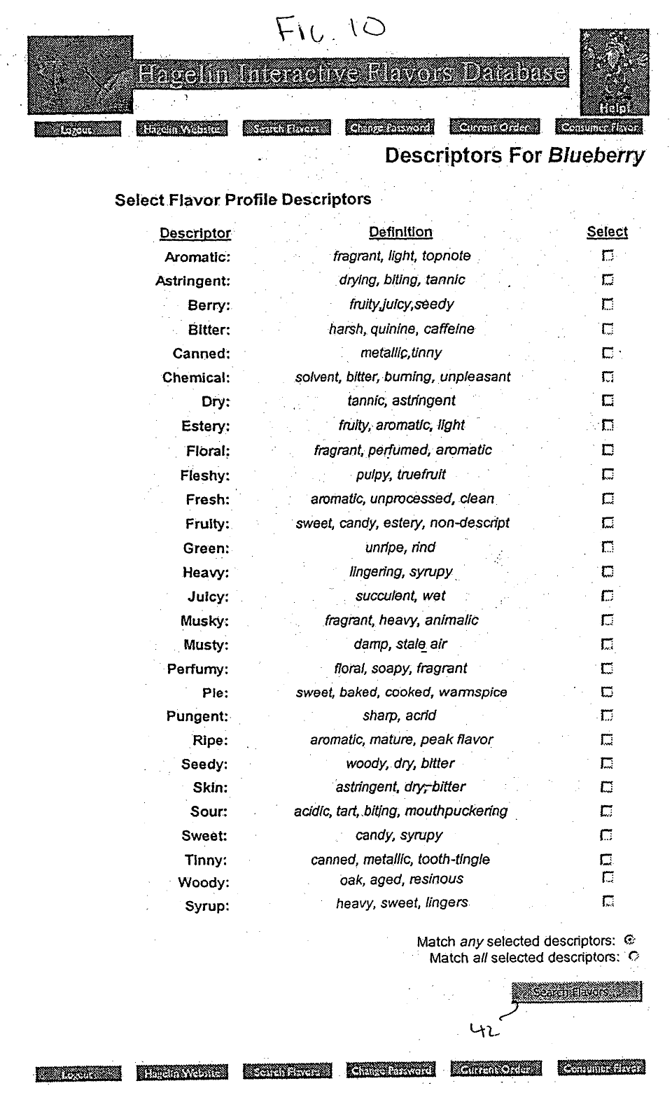

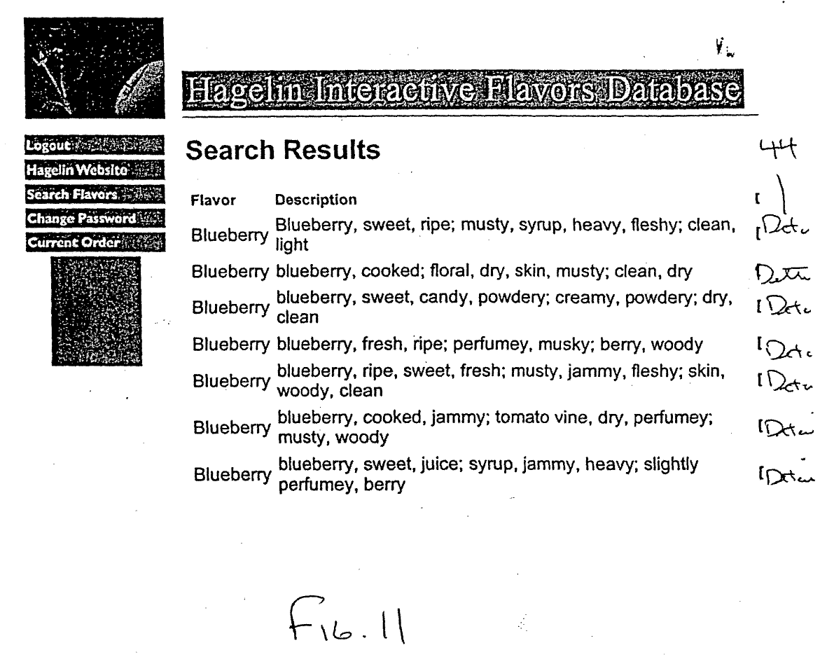

After selecting a flavor, the consumer is prompted to click the continue button 40 and the consumer is asked to select flavor descriptors for the chosen flavor, for example, blueberry, as shown in FIG. 10. This page is provided only when the user indicates a desire to search using specific descriptions (as discussed with regard to the web page shown in FIG. 9). If searching with all descriptions is chosen, the user would simply move to the Search Results web page shown in FIG. 11 without being prompted to identify specific descriptions. FIG. 10 required that the user select amongst various descriptors provided with definitions. With regard to blueberry, the descriptors may include, aromatic, astringent, berry, bitter, canned, chemical, dry, estery, fleshy, floral, fresh, fruity, green, heavy, juicy, musky, musty, perfumey, pie, pungent, ripe, seedy, skin, sour, sweet, syrup, tinny or woody. In addition to selecting individual descriptors, an individual may search using all available descriptors and may retrieve available flavors matching any of the descriptors or matching all of the selected descriptors. The descriptor pages for the various flavors differ depending upon the selected flavors and these pages are included in Appendix A

Once the consumer has selected all of the criteria relating to the desired flavor, the user is prompted to click the “Search Flavors” button 42. Thereafter, the consumer is provided with a search results list. With reference to FIG. 11, a search results list is provided for blueberry flavor in which all available descriptors were searched. No legal status was designated and water solubility was designated. With reference to FIG. 11, seven blueberry flavors are available in accordance with the designated search results. After reviewing the description of the various flavors available, a user may obtain further information by clicking the “Details” button 44.

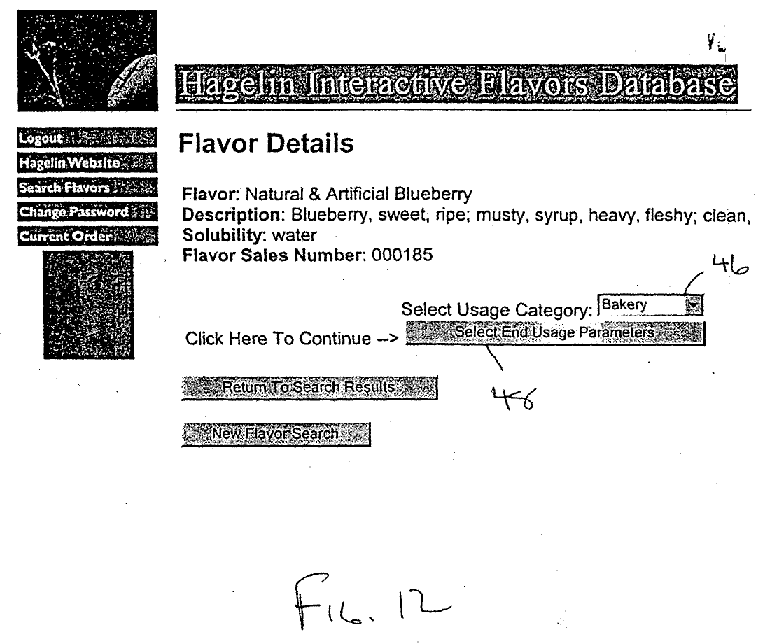

For example, and with reference to details regarding the blueberry flavor having the following description: “blueberry, sweet, ripe, musty, syrup, heavy, fleshy, clean, light”, the flavor details are provided in FIG. 12. Specifically, this is Flavor Sales Number 000185, is water soluble, is a natural and artificial blueberry flavor and is “blueberry, sweet, ripe, musty, syrup, heavy, fleshy, clean, light”. If this flavor is unacceptable, the user may return to the search results or begin a new flavor search. If, however, this flavor is desired for usage, the consumer is requested to once again select the usage category (for example, bakery, beverage, confections, dairy and/or oral care) 46 and select end usage parameters 48.

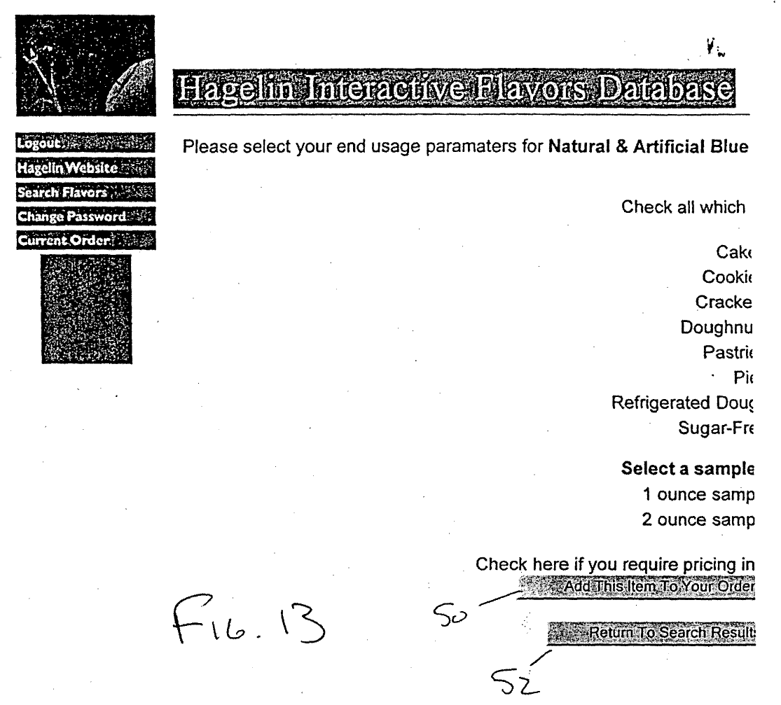

Thereafter, a screen as shown in FIG. 13 is exhibited. This web page requests that the user select end usage parameters for the designated natural and artificial blueberry. In accordance with the preferred embodiment of the present invention, the various usage parameters maybe selected from cakes, cookies, crackers, donuts, pastries, pies, refrigerated dough and/or sugar-free. In addition, a user may select a one-ounce sample or a two-ounce sample and may request pricing information.

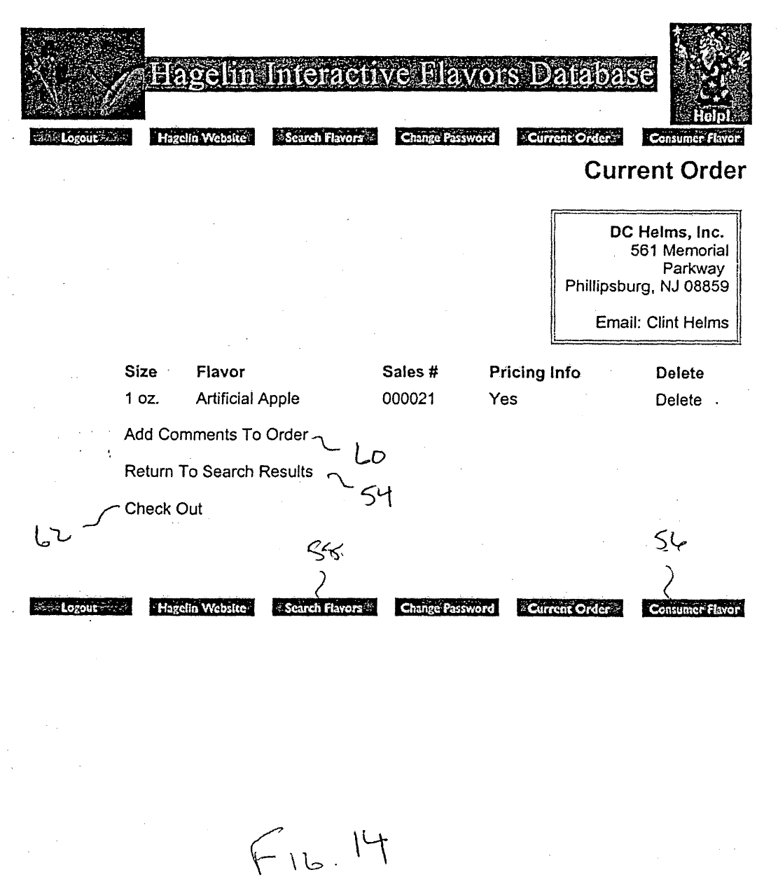

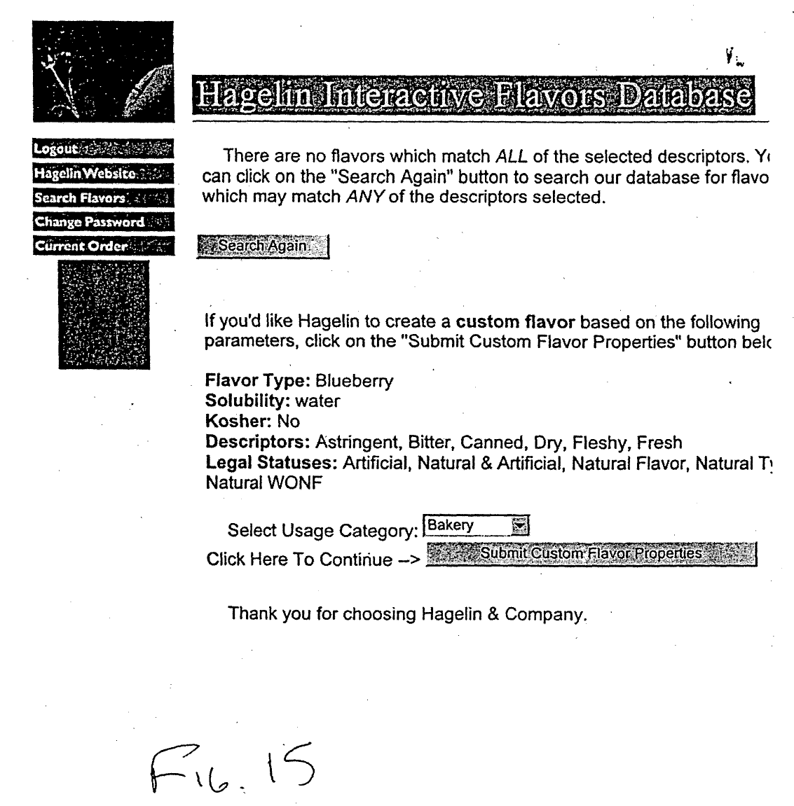

After designating the various usage parameters, the consumer may add this item to his or her order 50 or return to the search results 52. If the user wishes to add this to a current order, the user is provided with an order sheet (see FIG. 14) wherein the user may return to search results 54, request consumer product flavor 56, or conduct a new flavor search 58. The user may also add order comments 60 and/or check out 62.

Where various flavors are not available, the user is provided with a web page as shown in FIG. 15. The web page indicates that no flavors are available which match all of the selected descriptors. The user is then prompted to either search again 64 or request the creation of a custom flavor based upon the selected parameters 66.

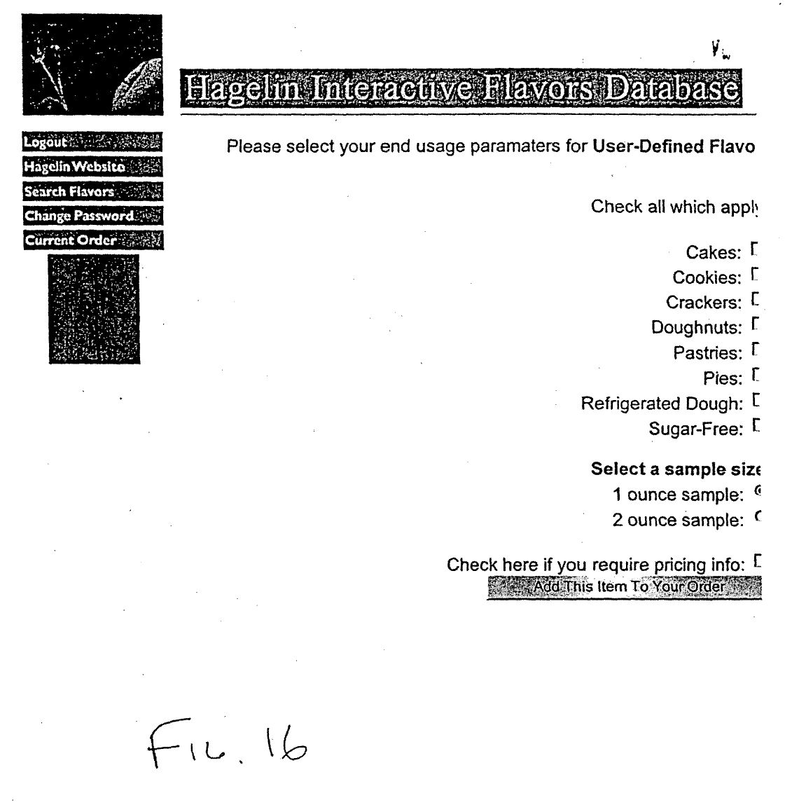

Assuming the user wishes to submit the custom flavor properties, the user will select a usage category from bakery, dairy, beverage, confections and/or oral care and submit the order for custom flavor creation by selecting link 66. Thereafter, and as with ordering of prepared flavors, the user is asked to select the end usage parameters for a user defined flavor and the item is then added to the order in the manner discussed above (see FIG. 16).

The present system allows consumers to interactively create and order flavors without the need for interaction with a customer service agent. This allows consumers to try a variety of flavors in a convenient and expeditious manner.

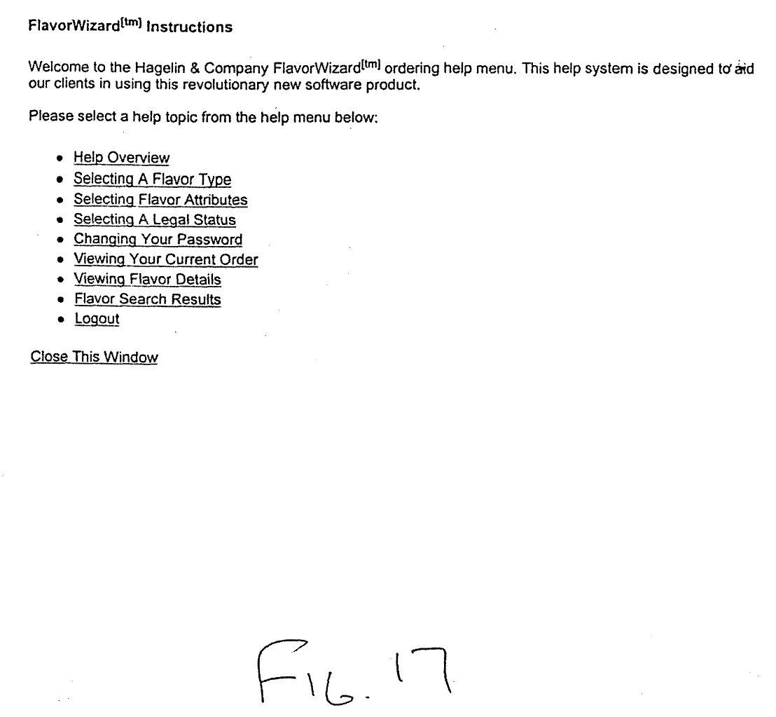

While many consumers are computer savvy and will not need substantial assistance in utilizing the present system, a help page is provided. As shown in FIG. 17, the help page provides information with regard to “Help Overview”, “Selecting a Flavor Type”, “Selecting Flavor Attributes”, “Selecting a Legal Status”, “Changing Your Password”, “Viewing Your Current Order”, “Viewing Flavor Details”, “Flavor Search Results” and “Logout”. With regard to the Help Overview page, help overview instructs consumers:

That this system is designed to let our valued customers browse our flavor library and request sample flavors. All data transactions occur in real-time, so as soon as a flavor sample is requested that sample request is immediately available to Hagelin personnel.

Before you can use the FlavorWizard™ application, you must have a valid user name and password to log into the application server. All user names and passwords are initially assigned by Hagelin personnel, but all users may change their password once they login.

Each flavor is identified by the following parameters:

Flavor Type

The Flavor type represents the most general flavor description; such as Pineapple, Almond, Coffee or Strawberry.

Flavor Descriptors

Each unique flavor in the Hagelin flavor library has a set of descriptive keywords which further describe the attributes of the flavor. The flavor descriptors are terms which may be typically used to describe a specific flavor type. All flavor types have a set of common descriptors; however, flavors may also be found by keywords, if the descriptor you require is not listed.

Legal Status

All flavors must have a legal status which describes the flavor composition; such as Natural or Artificial.

Solubility

All flavors in the Hagelin flavor library are either water soluble or oil soluble. When searching the flavor library, please select the solubility which suits your end usage.

Kosher Requirements

If your end usage is a kosher product, select Kosher flavor required when searching the flavor library.

In the event that a flavor search returns no results, your requested flavor parameters are saved and Hagelin flavor engineers will create a flavor which meets your requested criteria. This feature allows our clients to define ‘virtual’ or ‘user-defined’ flavors. Just because your search didn't return any listed results does not mean that Hagelin & Company cannot meet your needs.

With regard to the “Selecting a Flavor Type”, the help page states: “Please use your mouse to highlight the flavor type that you are looking for. You will be automatically prompted to the next section after you press ‘Next’”.

With regard to “Selecting Flavor Descriptors”, the help page states:

Using your mouse, please check as many descriptors as you would like your flavor to have. You may check as few or as many descriptors as adequately describe the flavor you are looking for. If you would like to search the flavor database, but aren't sure exactly what descriptors you're looking for, check the box labeled Check here to search using all available descriptors. Checking that box tells the FlavorWizard™ application to find all flavors which match the rest of your search criteria.

With regard to “Selecting Flavor Using Any Descriptors”, the help page states: “Selecting this will search our database of flavors that contain any of the attributes you have selected. For example, if you select “juicy”, “sweet” and “fresh”, you may have flavors returned that have a list of attributes with only one, such as “fresh”, matching your request”.

With regard to “Selecting Flavor Using All Descriptors”, the help page states: “Selecting this will search our database for flavors that only contain all of the attributes you have selected”.

With regard to “Selecting Legal Status”, the help page states: “Please select the type of flavor you need; e.g.: artificial, natural and artificial Note: you may select more than one, or none at all. If you don't select a legal status, all flavors which match the rest of your search criteria will be returned, regardless of their legal status”.

With regard to “Flavor Search Results”, the help page states:

If the FlavorWizard™ is able to find flavors which meet your search criteria, a list of flavors will be returned. You can view the details of any flavor returned in the search by clicking on the “Details” link associated with a flavor.

If the FlavorWizard™ was unable to find any flavors which matched your search criteria, you may have the opportunity to order a “User-Defined” flavor. You will have this option ONLY if your search criteria contained all of the following:

Specific, selected descriptors. If you selected “Search using all available descriptors” on the Flavor Search form, you will not be able to add a “User-Defined” flavor sample request to your order.

You selected one or more legal statuses. If you did not select any legal statuses on the Flavor Search form, you will not be able to add a “User-Defined” flavor sample request to.

With regard to “Viewing Flavor Details”, the help page states:

After searching the flavor database, the FlavorWizard™ application will return a list of results. To view the details of any flavor returned by the search, click on the “Detail” link

When the details for a particular flavor are displayed, you have the opportunity to add that flavor to your current order. If you decide to add the flavor to your order, select the End Usage Category that you will be evaluating the flavor for.

If, after viewing the details of a particular flavor, you decide that it's not appropriate for your application, you may return to the results from your search by clicking on the “Return To Search Results” button. You may also start a new search by clicking on the “New Flavor Search” button.

With regard to “Reviewing Your Order”, the help page states:

Each time an item is added to your order, your current order is displayed on the screen. You can delete any item from your current order by clicking on ‘Delete’ at the end of the order line item.

Once you've completed selecting flavor samples, you click on the ‘Check Out’ button below your order. By clicking on the ‘Check Out’ button, your order is marked as complete and Hagelin personnel are notified that your order has been placed and you're automatically logged out of the FlavorWizard™ application”.

With regard to “Changing Your Password”, the help page states:

All users of the FlavorWizard™ software have unique user names and passwords. Initially, your username and password is assigned by Hagelin personnel. To change your password, select Change Password from the menu. You will be prompted for your new password, which must be entered twice.

Remember that passwords are case-sensitive and must be between four and sixteen characters in length. If you forget your password, the FlavorWizard™ software hasn't, and the login form provides a link for forgotten passwords. Forgotten passwords can always be retrieved with a known user name, and may be retrieved by a known email address, if your email address is unique. When retrieving a lost password, the password is emailed to the address associated with your user name.

If you can't remember your user name and your password, please contact Hagelin personnel and a new user name and password will be assigned. Since user names and passwords are only stored in an encrypted format, Hagelin personnel will not be able to tell you your password if it's been forgotten.

Finally, with regard to “Logout”, the help page states:

When you've finished selecting flavor samples for your order, click on the “Logout” link in the left menu, or on the “Check Out” button which appears at the bottom of your sample order. Logging out helps assure that your flavor sample request is handled expeditiously by Hagelin personnel.

Please logout when you are finished using the FlavorWizard™ Application!

When you logout, an email is sent to Hagelin personnel which informs them that your order has been placed. If you don't logout your order may not be handled by Hagelin personnel as efficiently, since your order will not be marked as “Complete”.

While the preferred embodiment has been shown and described, it will be understood that there is no intent to limit the invention by such disclosure, but rather, is intended to cover all modifications and alternate constructions falling within the spirit and scope of the invention.

1. A system for the distribution of flavors, comprising:
a plurality of consumer workstations linked to a central processing hub;
the central processing hub including means for providing consumers with information regarding flavors, the means for providing including a flavor search system through which a consumer may identify desired flavor based upon a series of input criteria.

2. The system according to claim 1, wherein the criteria includes general flavor type.

3. The system according to claim 2, wherein the criteria further includes flavor descriptors.

4. The system according to claim 2, wherein the criteria further includes flavor legal status.

5. The system according to claim 4, wherein the flavor legal status is chosen from the group consisting of artificial, natural and artificial, natural flavor, natural type and natural WONF.

6. The system according to claim 2, wherein the criteria further includes solubility of the flavor.

7. The system according to claim 2, wherein means for providing further prompts the user to identify the usage category for the chosen flavor.

8. The system according to claim 7, wherein the usage categories are selected from the group consisting of bakery, dairy, beverage, confections and oral care.

9. The system according to claim 1, wherein means for providing further prompts the user to identify the usage category for the chosen flavor.

10. The system according to claim 9, wherein the usage categories are selected from the group consisting of bakery, dairy, beverage, confections and oral care.

11. The system according to claim 1, wherein the means for providing also including means for permitting a user to select the preparation of a custom flavor.

12. The system according to claim 1, wherein the consumer workstations and the central processing hub are connected via the Internet.

13. The system according to claim 1, further including means for providing general information regarding flavors.
